(19) United States
(12) Patent Application Publication
(10) Pub. No.: US 2010/0222053 A1
(43) Pub. Date: Sep. 2, 2010

(54) ARRANGEMENT AND METHODS FOR ESTABLISHING A TELECOMMUNICATION CONNECTION BASED ON A HEURISTIC MODEL

(76) Inventors: AthuluruTirumala GiriSrinivasaRao, San Francisco, CA (US); Ajay Mittal, Fremont, CA (US); Marc Solsona-Palomar, San Jose, CA (US)

Correspondence Address: IPSG, P.C., P.O. BOX 700640, SAN JOSE, CA, 95170, US

(21) Appl. No.: 12/395,216

(22) Filed: Feb. 27, 2009

(51) Int. Cl. H04W 4/00; H04W 36/00

(52) U.S. Cl. 455/432.1; 455/436

(57) ABSTRACT

An arrangement for managing a telecommunication session for a plurality of mobile communication devices that includes at least a first mobile communication device and a second mobile communication device is provided. The arrangement includes a mobility gateway, which is configured to communicate with the mobility client software of the first mobile communication device, wherein the first mobile communication device is a subscriber of the mobility gateway. The mobility gateway includes computer readable code implementing a model configured for collecting and storing environmental data about a set of access points. The environmental data includes data collected during the telecommunication session between the first mobile communication device and the second mobile communication device. The environmental data also includes data collected during previous telecommunication sessions supported by the mobility gateway. The environmental data is employed by the mobility gateway to manage the telecommunication session for the first mobile communication device.

### CROSS REFERENCE TO RELATED APPLICATIONS

The present invention is related to the following application, all of which are incorporated herein by reference:

Commonly assigned application entitled “Enterprise-Managed Wireless Communication,” by Karia et al., Attorney Docket Number DVTS-P001, application Ser. No. 11/538,042 Filed on Oct. 2, 2006.

### BACKGROUND OF THE INVENTION

In today's society, a popular tool utilized by many people is a telecommunication device (e.g., cellular telephone, telephone, smart device, etc.). With a telecommunication device, a user is able to develop, establish and maintain relationships despite geographic separation. Especially popular are telecommunication devices that enable a user to be mobile, hereinafter refers to as mobile communication devices. With a mobile communication device, a user is able to communicate with another party while moving from point A to point B. For example, Bob is talking to Tom on a mobile communication device while Bob is walking from his office to a coffee shop downstairs. Due to the mobile communication device ability to maintain telecommunication session while a user is moving, Bob is able to continue his conversation with Tom. Accordingly, the mobility aspect of a mobile communication device has made a mobile communication device an essential tool in everyday life.

While a user of a mobile communication device is exchanging information with another party, the user may roam outside of his current network. In an example, when Bob left his office to go buy a pastry in the coffee shop, Bob may have roamed outside of the current network that supports his telecommunication session. When the user roams outside of his current network, the carrier may have to actively search for a second network to enable handoff in order to prevent the current telecommunication session from being terminated.

Even though the carrier may be able to maintain the telecommunication session, the quality of the call may not always be preserved. In an example, when the mobile communication device is switched over to a second network, it is not unusual for the user's experience to worsen. For example, when Bob's mobile communication device is switched over to a second network, Bob may hear static noise. One reason for the deterioration in the call quality (e.g., static noise) may be due to the current load that the second network may be handling. In other words, although the second network is available to handle the additional telecommunication session, the second network may already be at a critical state since the number of telecommunication sessions the second network may be handling may be above the level that the second network may be capable of handling in a manner that will provide a satisfactory user experience.

However, in the prior art, the carrier network may perform the switch without taking into consideration the load of the potential network. Thus, if a second network is available to accept the switch, the carrier may perform the switch regardless of the second network's ability to provide a good user experience. As a result, roaming has not always provided a continuous satisfactory user experience when a handoff is required.

### BRIEF SUMMARY OF THE INVENTION

The invention relates, in an embodiment, to an arrangement for managing a telecommunication session for a plurality of mobile communication devices that includes at least a first mobile communication device and a second mobile communication device wherein the first mobile communication device having implemented therein a mobility client software. The arrangement includes a mobility gateway wherein the mobility gateway is configured to communicate with the mobility client software of the first mobile communication device, wherein the first mobile communication device is a subscriber of the mobility gateway. The mobility gateway includes computer readable code implementing a model configured for collecting and storing environmental data about a set of access points. The environmental data includes data collected during the telecommunication session between the first mobile communication device and the second mobile communication device. The environmental data also includes data collected during previous telecommunication sessions supported by the mobility gateway. The environmental data is employed by the mobility gateway to manage the telecommunication session for the first mobile communication device.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE SEVERAL VIEWS OF THE DRAWINGS

The present invention is illustrated by way of example, and not by way of limitation, in the figures of the accompanying drawings and in which like reference numerals refer to similar elements and in which:

FIG. 1 shows a simple diagram illustrating a telecommunication environment with a mobility service provider.

FIG. 2 shows, in an embodiment of the invention, a simple diagram illustrating a telecommunication environment with a heuristic model.

FIG. 3 shows, in an embodiment of the invention, a simple call flow.

FIG. 4A shows, in an embodiment of the invention, an example of a database that may be employed to store data collected about Wi-Fi access points.

FIG. 4B shows, in an embodiment of the invention, an example of a database that may be employed to store data collected about cellular access points.

FIG. 5 shows, in an embodiment of the invention, a simple diagram of an example of a virtual map of a telecommunication environment.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

As aforementioned, roaming may occur when a user on a mobile communication device is moving from point A to point B. Traditionally, the transfer between networks is performed by a carrier. Also, the decision about the transfer is usually conducted independent of input from the mobile communication device. Due to the lack of interaction between the mobile communication device and the carrier network, the mobile communication device may be transferred over to another network that may not always provide the user with the best user experience. Factors that may affect the quality of service provided may be due to many reasons. One reason may be due to the current capacity of the second network. In other words, the second network may already be at a high usage capacity. Another reason may be that the switch decision may often be made “on the fly” as the signal strength being received by the mobile communication device is lessening; therefore, a handoff to any available network, regardless of network capacity, may have to occur in order to maintain the telecommunication session. Furthermore, the cost to the user may not be taken into consideration when a handoff is occurring. In an example, the carrier network may be basing its decision on maintaining the telecommunication session instead of the cost associated with the new communication channel.

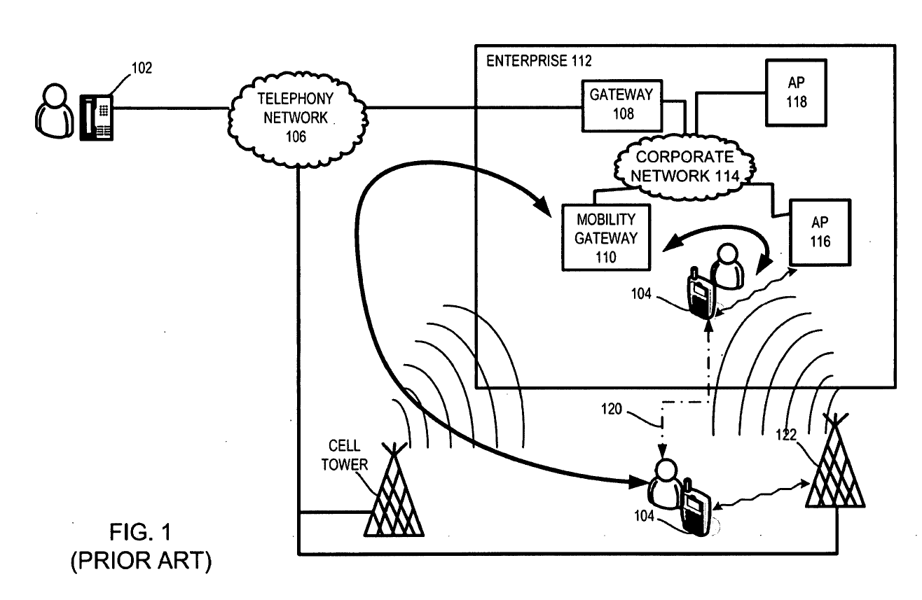

Alternatively, a telecommunication session may be managed by a mobility service provider, such as an enterprise with a mobile gateway, instead of by a carrier network. To facilitate discussion, FIG. 1 shows a simple diagram illustrating a telecommunication environment with a mobility service provider. Consider the situation wherein, for example, a user of a telecommunication device 102 is communicating with a user of a mobile communication device 104. The telecommunication session between the two parties is occurring through a telephony network 106 via a gateway 108, such as via a public broadcast exchange (PBX).

Mobile communication device 104 is a subscriber to a mobility service as provided by a mobility gateway 110. As discussed herein, a mobility gateway refers to a system that manages incoming and outgoing telecommunication sessions for its members. In an example, mobility gateway may be responsible for determining the type of network that may host the telecommunication session for mobile communication device 104, for example. In another example, mobility gateway may be responsible for determining when a handoff may occur for mobile communication device 104, for example.

In this example, mobility gateway 110 is implemented within an enterprise 112 and may be part of a wireless communication system of enterprise 112. Through a corporate network 114, mobility gateway 110 may be able to manage the different telecommunication needs of enterprise 112 and its members, such as mobile communication device 104.

Consider the situation wherein, for example, mobile communication device 104 is currently connected to access port 116, which is one of the access points (116 and 118) within enterprise 112. During the telecommunication session, the user of mobile communication device 104 may begin traveling along a path 120. In other words, the user of mobile communication device 104 is walking outside of enterprise 112. Since mobile communication device 104 is a subscribed member of mobility gateway 110, mobile communication device 104 may be interacting with mobility gateway 110. During the interaction, data may be transmitted between mobile communication device 104 and mobility gateway 110. Examples of data that may be transmitted between mobile communication device 104 and mobility gateway 110 may include channel loading and the quality of the telecommunication session. In an example, mobile communication device 104 may be transmitting its current status (e.g., proximity to access points, signal strength, etc.) to mobility gateway 110. For example, as mobile communication device 104 travels along path 120 and away from access point 116, the data that is being sent back to mobility gateway 110 may indicate the strength of the connection between mobile communication device 104 and access port 116.

When the signal strength is at a critical state, mobility gateway 110 may send a message to gateway 108 informing gateway 108 that mobile communication device 104 has roamed away from access point 116 and is roaming toward cellular tower 122. Upon receiving the message, gateway 108 may then establish a relationship with cellular tower 122 to allow mobile communication device 104 to connect with cellular tower 122 in order to maintain the telecommunication session. When the connection with cellular toward 122 has been established, the connection between mobile communication device 104 and access point 116 may be terminated. In another example, if Wi-Fi hotspots are available, mobility gateway may choose one of the Wi-Fi hotspots instead of cellular tower 122 since a connection established through a Wi-Fi hotspot is usually less costly than through a cellular tower. As can be appreciated from the foregoing, the mobility gateway provides a better user experience by interacting closely with the mobile communication device in order to facilitate handoff. By implementing a mobility gateway, enterprise 112 may have a better control over its telecommunication cost since enterprise 112 may consider cost as one of the factors for determining how a communication channel is established. Thus, the mobility gateway provides a telecommunication solution that addresses handoff while enabling the enterprise to control its cost.

In the prior art, decision about a handoff is generally made based on data that is currently available. In other words, the decision about a handoff is based on data collected and exchanged between the mobility gateway and the mobile communication device. In one aspect of the invention, the inventors herein realized that the mobility gateway may have a higher probability of establishing a good quality telecommunication session if more data about the plurality of access points (e.g., cellular access points, Wi-Fi access points, etc) is available for analysis.

In accordance with embodiments of the invention, a model is provided for enabling a mobility gateway to establish a telecommunication channel with an access point, especially during a roaming situation. Embodiment of the invention includes a model, such as a heuristic model, as a component of a mobility gateway. The heuristic model may include a set of databases in which data are being constantly collected and updated in order to provide detailed information about the available access points (e.g., Wi-Fi access points, cellular access points, etc.). Embodiment of the invention includes applying the heuristic model in order to create a virtual map of the access points that are available in order to enable the mobility gateway to make a knowledgeable decision about how a telecommunication channel may be established, especially during a roaming situation.

In this document, various implementations may be discussed using access point as an example. This invention, however, is not limited to access point and may include any unlicensed wireless band frequency. Instead, the discussions are meant as examples and the invention is not limited by the examples presented.

Also, in this document, various implementations may be discussed using heuristic model as an example. This invention, however, is not limited to a heuristic model and may include any mechanism or algorithm that may be employed to analyze a collection of data. Instead the discussions are meant as examples and the invention is not limited by the examples presented.

In an embodiment of the invention, the heuristic model may include data gathered from a plurality of mobile communication devices. Unlike the prior art, the data that are gathered may be stored in a set of databases that may be readily accessible to the mobility gateway, in an embodiment. Since die data are being collected from a plurality of mobility devices, the heuristic model may include logic for performing analysis to create a virtual map of access points that may be available. Hence a decision about establishing a telecommunication channel via an access point for a mobile communication device is no longer based just on data gathered between an interaction between the mobile communication device and a mobility gateway.

Instead, the decision may also be based on data gathered from other telecommunication sessions that may be currently conducted and/or previously conducted. In an example, if Richard, who is currently on a call with Tom, roams outside of his current network, the decision about a handoff is not only based on the data that is being sent between Richard's mobile communication device and the mobility gateway, but may also be based on data stored at the heuristic model. Thus, even before the critical state is reached, in which a handoff is required, the heuristic model may already be analyzing the data that is available to determine the best network to enable the switch. Accordingly, the decision about a handoff may not only include the availability of an access points but may also include other factors, such as the current usage of the access points, trends based on previous/current telecommunication sessions, availability of other access points, cost, signal strength, and the like. With the additional data, the mobility gateway may substantially reduce the possibility of a bad connection.

In an embodiment, the data gathered by the heuristic model may be employed to create a virtual map of the telecommunication environment. Accordingly, with the creation of a virtual map of the telecommunication environment for a mobile communication device, the decision for a handoff may be anticipated based on the path the user of the mobile communication device is traveling. In other words, instead of making a handoff decision due to the decrease in signal strength, the heuristic model may, in an embodiment, anticipate the need for a handoff based on the location of the mobile communication device and may begin determining potential access points that may provide the mobile communication device with a good telecommunication connection.

In addition, the heuristic model may be able to identify potential access points even if the access points may not currently be within the signal range of the mobile communication device. In an embodiment, the heuristic model may employ the signal strength of the available cellular towers to determine the availability of potential Wi-Fi access points. Since cellular towers generally provide a longer range signal, the heuristic model may perform triangulation, in an embodiment, to determine the location of the potential access points. In an example, based on the data collected and stored, the heuristic model is aware of a Wi-Fi access point available between two cellular towers. Hence, even if the Wi-Fi access point has not yet show up as a potential access point, the heuristic model may perform triangulation based on available cellular signals to determine whether or not the mobile communication device is approaching the Wi-Fi access point based on the path the user is moving.

The features and advantages of the present invention may be better understood with reference to the figures and discussions that follow.

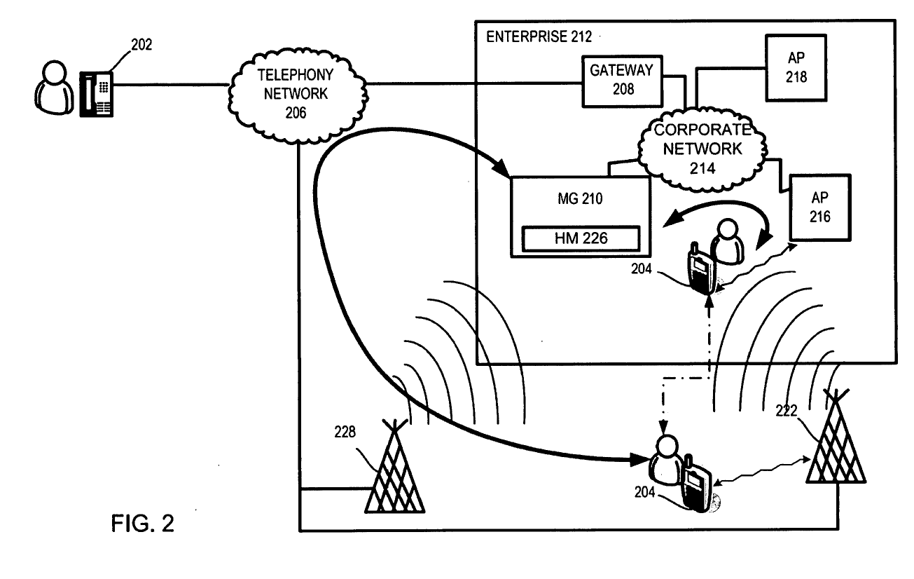

FIG. 2 shows, in an embodiment of the invention, a simple diagram illustrating a telecommunication environment with a heuristic model. Consider the situation wherein, for example, a user at telecommunication device 202 is communicating with a user at telecommunication device 204, the telecommunication session may traverse through a telephony network 206 to connect with a mobility gateway 210 via a gateway 208 and a corporate network 214.

In this example, telecommunication device 204 is a mobile communication device with a mobility client software installed, thereby enabling telecommunication device 204 to interact with mobility gateway 210. Assume that telecommunication device 204 is currently within enterprise 212 and is being connected via an access point 216. As can be appreciated from the foregoing, an enterprise 212 may have a plurality of access points, including access points 216 and 218. While telecommunication device 204 is within enterprise 212, telecommunication device 204 may be communicating with mobility gateway 210. In an example, telecommunication device 204 may be sending mobility gateway 210 information about its current status, such as the access point (216) that is supporting the current telecommunication session, the signal strength that telecommunication device 204 may be experiencing with access point 216, the existence of other access points that may be available to telecommunication device 204 (such as the existence of access point 218), the signal strength of access point 218, and the like. In an embodiment, the data being sent to mobility gateway 210 may be stored within a heuristic model 226.

While the user of telecommunication device 204 is communicating with telecommunication device 202, the user of telecommunication device 204 may begin to roam or travel away from access point 216. As the user roams, telecommunication device 204 may detect access points (such as cellular towers 222 and 228) that may be within close proximity to roaming telecommunication device 204. As the cellular towers are being detected by telecommunication device 204, data about the cellular towers may be sent to mobility gateway 210. Information that may be stored may include the cellular ID associated with each cellular tower, the signal strength of the each cellular tower, and the like.

With the information provided by telecommunication device 204 to mobility gateway 210, heuristic model 226 may be actively collecting data about the various different access points that may be available to telecommunication device 202 in order to facilitate decision-making by mobility gateway 210. In an example, mobility gateway 210 may determine based on the data available from heuristic model whether a handoff needs to occur. If a handoff is required, mobility gateway 210 may also be configured to determine which access point may enable telecommunication device 202 to maintain a good connection.

In an embodiment, the data being collected and sent to the heuristic model is stored and saved for further usage in establishing other telecommunication sessions and/or being applied to handle other roaming situations. Unlike the prior art, the data that may be collected and sent to mobility gateway 210 is not discarded after a telecommunication connection (e.g., handoff) has occurred. Instead, the data is stored in heuristic model 226 and may be utilized at a later date in determining a future telecommunication connection for telecommunication device 202 or any other subscribed mobile communication device.

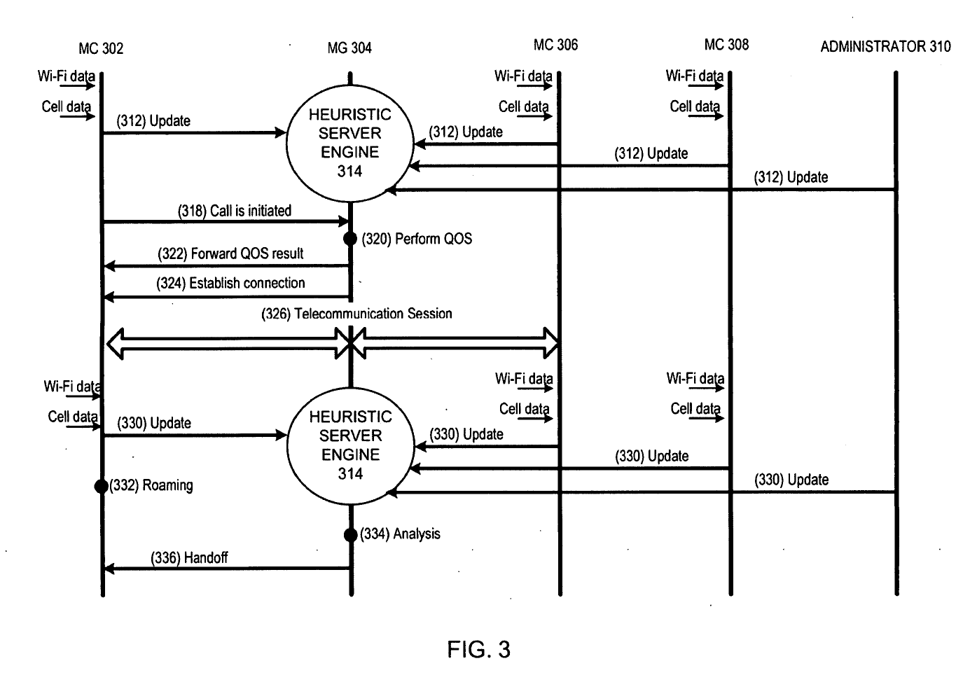

FIG. 3 shows, in an embodiment of the invention, a simple call flow. Consider the situation wherein, for example, a mobile communication device 302 has been activated and has registered with a mobility gateway 304. Mobile communication device 302 may be retrieving environmental data, such as data about available Wi-Fi access points and cellular access points, even if mobile communication device 302 is not currently active in a telecommunication session.

At a first step 312, in an embodiment, a heuristic server engine 314 is updated. In an example, the environmental data about the different access points may be forwarded to the heuristic model (e.g., heuristic server engine 314). In an embodiment, the heuristic model is a component of mobility gateway 304. In addition, heuristic server engine 314 may also be receiving environmental data from other subscribed mobile communication devices, such as mobile communication devices 306 and 308.

In an embodiment, heuristic server engine 314 may also be populated by administrator 310. Administrator 310 may pre-populate heuristic server engine 314 with data that may already be readily available or with rules that may define how a connection may be established, in an embodiment. In an example, administrator 310 may pre-populate heuristic server engine 314 with environment data, such as locations of access points, that administrator 310 may be aware of without having to wait for the information to be gathered by the subscribed mobile communication devices. In another example, administrator 310 may also define policy rules establishing conditions under which access points, for example, may be made available or when certain access points may be unavailable due to usage status. In addition, administrator 310 may also set priority rules defining the hierarchy for establishing a connection. For example, a salesperson that interacts with external clients may have higher priority in establishing a call than an engineer who has limited outside interaction. In yet another example, administrator 310 may also establish the cost guidelines for establishing connection through the different access points.

With the data stored at heuristic server engine 314, analysis may be performed before a telecommunication connection is established and/or a handoff is performed. In an example, at a next step 318, a user of mobile communication device 302 wants to initiate a call by entering a destination number (e.g., telephone number).

At a next step 320, a quality of service evaluation may be performed to determine the status of available access points. In an example, if three access points are available from which mobile communication device 302 may establish a telecommunication connection, a quality of service evaluation may be performed on all three access points. In an embodiment, the quality of service evaluation may be performed before the destination number is entered. In other words, the quality of service evaluation may be performed in anticipation of a request for a potential telecommunication session. In another embodiment, the quality of service evaluation is performed when at least the first number of the destination number is entered. Since mobile communication device 302 is interacting with mobility gateway 304, mobility gateway 304 is aware of the changing status of mobile communication device 302. When the first digit (e.g., number) of the destination number is entered onto mobile communication device 302, the changing status of mobile communication device 302 may be communicated to mobility gateway 304. Upon receiving the changing status of mobile communication device 302, mobility gateway 304 may begin the quality of service evaluation. In an embodiment, the quality of service evaluation may be performed by a logic component within the heuristic model. In another embodiment, the logic component may be a component of mobility gateway 304 but external to the heuristic model.

At a next step 322, the result of the quality of service evaluation is sent to mobile communication device 302. Since mobile communication device 302 and mobility gateway 304 are interacting with one another, the result of the quality of service evaluation may be shared with mobile communication device 302. Step 322 is an optional step and a telecommunication connection may be established without sharing the result with mobile communication device 302.

At a next step 324, mobility gateway 304 may establish a telecommunication connection for mobile communication device 302 based on the result from the analysis performed by heuristic service engine 314. Since the telecommunication connection is established based on data gathered from a plurality of sources (e.g., including but are not limited to data gathered by mobile communication device 302, data gathered by other mobile communication devices, data provided by administrator 310, and data gathered from previous telecommunication sessions), a telecommunication connection may be established that takes into account the different factors that may impact the signal strength and/or quality of the signal in order to provide mobile communication device 302 with a good connection.

In an example, mobile communication device 302 may be within close proximity to an access point A; however, access point A, based on the data gathered by heuristic server engine 314, may be currently overloaded and may not be able to establish a telecommunication connection that may provide the user of mobile communication device 302 with a good user experience. Instead, a second access point B, which may be slightly further away than access point A, may be available for establishing the telecommunication connection. In the prior art, the telecommunication connection may have been established through access point A, thereby providing a telecommunication connection that may not provide the user with a good user experience. In an example, the telecommunication connection may have a bad signal, the connection may experience static noises, and the like. Unlike the prior art, the heuristic model performs analysis to determine the quality of service that may be provided through the different available access points before establishing a connection between a mobile communication device and an access point. As a result, the possibility of a “bad connection” is significantly reduced. Thus, with the heuristic model, a better user experience maybe provided.

At a next step 326, the telecommunication session is established and mobile communication device 302 is connected to the destination telecommunication device, such as mobile communication device 306. In an example, mobility gateway 304 may direct a PBX interface to establish a connection with access point B in order to enable the telecommunication session with the destination telecommunication device.

During the telecommunication session, data collected by mobile communication device 302 is being sent to mobility gateway 304 (step 330), in an embodiment. The data may then be forwarded to heuristic server engine 314. As aforementioned, the data being collected may include status of mobile communication device 302, the location of mobile communication device 302, the status of access points that may be within close proximity to mobile communication device 302, and the like.

If the user of mobile communication device 302 decides to roam (step 332) away from access point B, heuristic server engine 314 may be able to employ the data being collected by mobile communication device 302 and the data stored within itself to determine the need for a handoff and/or the access point that may replace access point B to establish the telecommunication connection for mobile communication device 302 (step 334). The data collected from the various different devices may enable the heuristic module to determine the access point that may best support the new telecommunication connection in order to enable mobile communication device 302 to maintain its telecommunication session with mobile communication device 306. In an example, heuristic server engine 314 may determine that mobile communication device 302 has roamed too far away from any Wi-Fi access point and that a connection may only be established with a cellular tower.

In another example, heuristic server engine 314 may determine that mobile communication device 302 is roaming away from access point B and is roaming toward access points C and D. However, based on analysis (e.g., quality of service evaluation) performed by heuristic server engine 314, access point C is currently loaded and is unable to support another telecommunication connection while access point D still has capacity. As a result, a handoff (step 336) may occur switching mobile communication device 302 from access point B over to access point D.

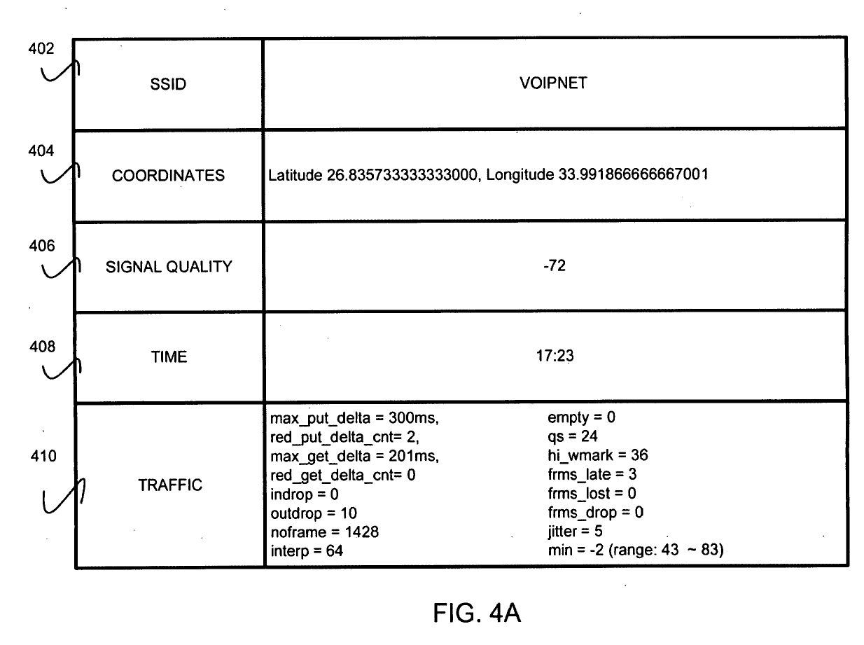

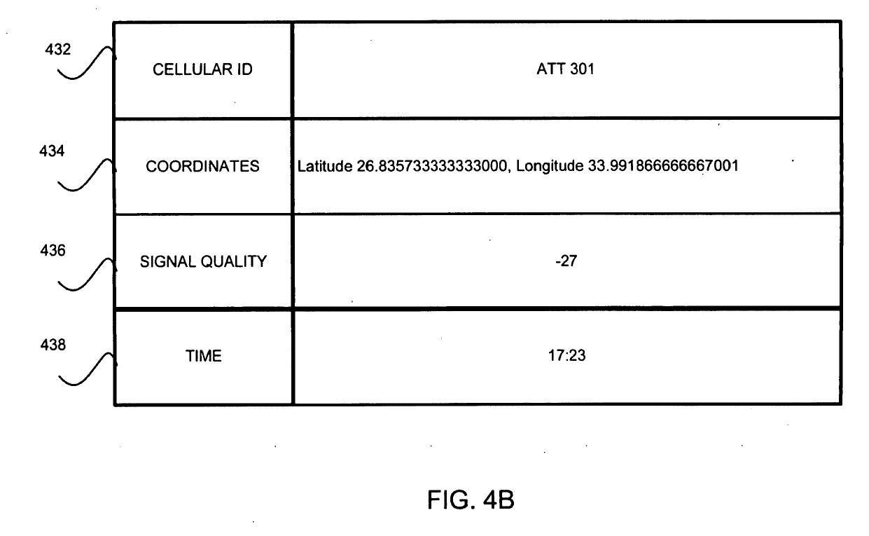

As can be appreciated from the foregoing, the heuristic model is collecting data from a plurality of data sources (e.g., mobile communication devices, administrator, etc.). The data collected may be stored within a set of databases. FIGS. 4A and 4B show examples of the different types of databases that may be employed to store the data collected by the heuristic model.

FIG. 4A shows, in an embodiment of the invention, an example of a database that may be employed to store data collected about Wi-Fi access points. An example of data that may be included in the database is a unique identification (ID) (e.g., service set identification 402) of each Wi-Fi access point, such as a basic service set identifier (BSSID) and extended service set identifier (ESSID). Another type of data that may be collected and stored is a set of coordinates 404 associated with each access point. The coordinates may be GPS (global positioning system) coordinates. Another data type that may be gathered is the signal quality 406 associated with each access point. In an example, signal quality may include, but are not limited to a RSSI (received signal strength indicator), which is the amount of power within a signal, and a SNR (signal-to-noise ratio), which is the ratio of signal power to background noise. In addition, the type of traffic pattern 410 that may be occurring at an access point at a specific time 408 may also be gathered. In an example, during the noon time period, access point C (which is located near the lunch room) may experience heavy usage since many mobile communication device may be trying to establish telecommunication connection through access point C; however, at 5:32 PM, access point C may experience little or no usage since the lunch room is not usually busy and/or occupied during this time period.

In an example, the user of mobile communication device 302 of FIG. 3 is walking from access point B to access point C during lunchtime. In the prior art, a handoff may have transpired with a new connection established with access point C. However, during lunchtime, access point C is usually heavily loaded, thereby causing connection supported by access point C to experience a weak and/or distorted signal. With the heuristic model, data about access point C (e.g., signal strength) may be stored and may be employed to perform an analysis of the availability of access point C. Unlike the prior art, the heuristic model may identify access point C as being unavailable (due to usage capacity) and may perform the handoff by establishing a connection with another access point. In another example, if no other access point is available, the heuristic model may make a determination that even though the signal strength through access point B may be deteriorating, access point B may still provide a better connection than access point C. Thus, the heuristic model may determine that no handoff needs to occur. Accordingly, a telecommunication connection may have to be established with the overloaded access point if no other access point is available. However, with the heuristic model, different options are analyzed in order to provide the user of the mobile communication device with the best possible user experience.

FIG. 4B shows, in an embodiment of the invention, an example of a database that may be employed to store data collected about cellular access points. The database may include a cellular ID 432 that is unique to a cellular tower. The database may also include coordinates 434 of each cellular tower and the signal quality 436 associated with the cellular tower, and the specific time 438.

With the data collected, a virtual map may be created of the available access points. Even if actual coordinates, such as GPS coordinates, are not available, triangulation may occur, enabling an approximation of the location of an access point. In other words, an access point location may be determined based off the proximity to other access points. Over time, the data gathered by the heuristic model may enable the heuristic model to refine the virtual map, thereby enabling the heuristic model to provide a better analysis of potential access points that may be available for making a telecommunication connection.

Besides employing the data gathered to determine which access point may best provide a user with a good user experience, the data gathered by heuristic model may also be employed to determine when a Wi-Fi service may be activated. Those skilled in the art are aware that activating a Wi-Fi service enables the mobile communication device to actively search for potential Wi-Fi access points for establishing a telecommunication connection. However, the active search may negatively impact the battery life of the mobile communication device and/or the limited processing capability of the mobile communication device. To minimize drainage of the battery and/or limit unnecessary usage of the processor, the heuristic model may be employed to notify the mobile communication device when a Wi-Fi access point is available. In an example, the heuristic model may perform analysis, such as triangulation on known cellular tower signal strength, to determine the existence of Wi-Fi access points. With the aid of the heuristic model, the user is able to take advantage of the lower cost of establishing a connection through a Wi-Fi access point without requiring a mobile communication device to actively search for available Wi-Fi access points, thereby minimizing battery and/or processor usage.

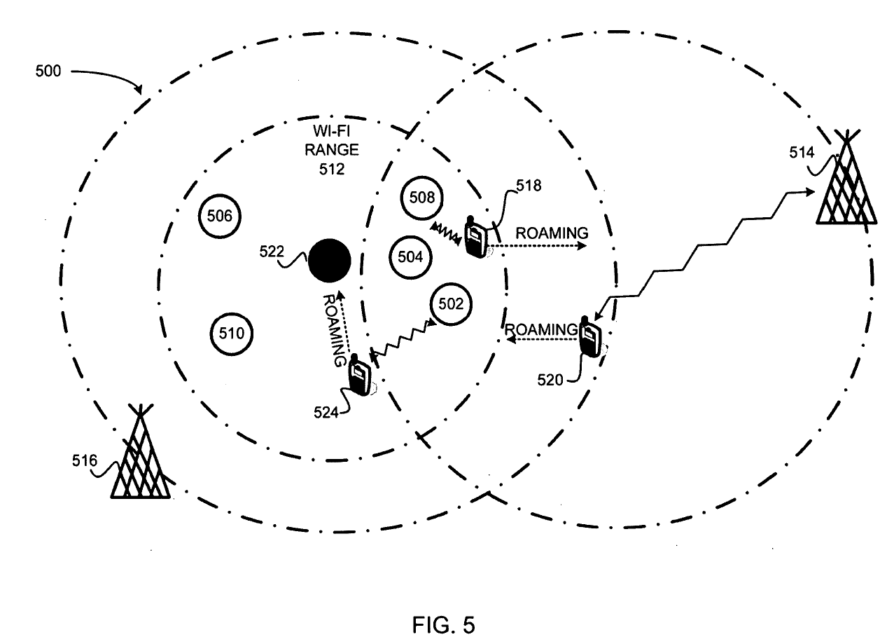

FIG. 5 shows, in an embodiment of the invention, a simple diagram of an example of a virtual map of a telecommunication environment. Telecommunication environment 500 may include a Wi-Fi range 512 that may be comprised of a plurality of access points, including access points 502, 504, 506, 508, and 510. In addition, Wi-Fi range 512 may be located within two cellular ranges, cellular ranges 514 and 516.

Consider the situation wherein, for example, a mobile communication device 518 currently has a telecommunication connection via access point 508. As mobile communication device 518 moves away from access point 508, the heuristic model may be able to determine, based on the data collected about telecommunication environment 500, the access points that may be available if a handoff is required. In addition, the heuristic model may also be able to determine when mobile communication device may be approaching the edge of Wi-Fi range 512. In anticipation, the heuristic model may be able to identify cellular access points available for the handoff and perform an analysis to determine when the handoff may have to take place.

In another example, a user of a mobile communication device 520 is traveling from a cellular network into Wi-Fi range 512. Based on the data collected about telecommunication environment 500, the heuristic model may be able to determine when mobile communication device 520 is moving closer to the edge of Wi-Fi range 512, even if none of the Wi-Fi access points are yet close enough to mobile communication device to be identified as available access points. Based on the virtual map, the heuristic model may be able to determine that if mobile communication device 520 continues to travel along the current path, a handoff may occur since a less expensive network (e.g., Wi-Fi range 512) may become available.

In addition, not only is the heuristic model able to determine when mobile communication device 520 is approaching Wi-Fi range 512, but the heuristic model may also be able to determine which access points may be available for the handoff. For example, as mobile communication device 520 approaches the edge of Wi-Fi range 512, access points 502, 504, and 508 may become available. Although all three access points may be available, not all three access points may have the capacity to handle an additional telecommunication connection. In an example, access point 502 may have already reached its critical state and may not be able to support an additional connection. As a result, the heuristic model may determine that even though access point 502 may be the closest to mobile communication device 520, the handoff may be better supported by another access point, such as access point 504, for example.

In another example, a mobile communication device 524 may currently be connected via access point 502. During the telecommunication session, the user of mobile communication device 524 may be traveling toward the edge Wi-Fi range 522, which is a region within Wi-Fi range 512 in which no Wi-Fi service is available. As a result, the heuristic model may be able to identify the region that may have inadequate Wi-Fi service and may provide an alterative for maintaining the current telecommunication session. In an example, the heuristic model may identify available cellular service that may be available to support the current telecommunication session.

As can be appreciated from the foregoing, the data collected by the heuristic model may be applied to create a virtual map of the telecommunication environment (e.g., cellular and Wi-Fi networks, for example). Accordingly, with the heuristic model, the mobility gateway may be able to make informed decision about when a handoff may need to occur and which access point may be best to establish the connection. The decision may be based on a plurality of factors. In an example, the heuristic model may consider whether or not a handoff needs to occur, based on the quality of service evaluation. If a handoff needs to occur, the heuristic model may then take into consideration which access points are available. If more than one access point is available, the heuristic model may have to determine which Wi-Fi access point may provide the user with a good user experience. In addition, the heuristic model may also take into consideration the cost associated with each access point. In one example, if all factors are comparable, the mobility gateway may establish a connection through the access point that may provide the best signal strength at the least cost based on the heuristic model analysis. If the quality of the service is not the same, then the mobility gateway may establish the connection through the access point that may have the higher quality of service evaluation as determined by the heuristic model. In yet another example, cost consideration may be ignored if quality of service is desirable.

As can be appreciated from the foregoing, the ability for a mobility gateway to establish a good quality telecommunication session (especially during a handoff) for a mobility client may depend on several factors. In an example, signal flow may have to be addressed as the mobility client is transferred from a first network to a second network. In an example, the mobility client is being transfer from a cellular network to a Wi-Fi network. In order to perform the handoff, the mobility gateway may have to ensure that data package is not lost and that the handoff is seamless to the user of the mobility client.

The mobility gateway may also, collect data that may enable the mobility gateway to make handoff decision, for example. In an example, the data that may be collected may include Wi-Fi signal strength, retransmission rate of the associated access point and the neighboring access points, jitter state, bandwidth calculations, location of the access points, historical usage of access points, cellular towers location, and the like. With the data gathered, the mobility gateway may not only determine when a handoff may occur but the mechanism for performing the handoff. With the data gathered, the mobility gateway may create a map of access points and their usage availability. By applying the map and the data gathered, the mobility gateway may establish high quality telecommunication sessions, determine when handoff may occur, and determine the mechanism for performing the handoff.

As can be appreciated from one or more embodiments of the present invention, the heuristic model transforms the mobility gateway from a seemingly reactive system to a system capable of identifying multiple potential access points available for establishing a telecommunication connection based on the location of the mobile communication device. With the heuristic model, “on the fly” decision about a telecommunication connection is substantially eliminated. Thus, the heuristic model provides the mobility gateway with the ability to intelligently determine the best possible telecommunication connection for a mobile communication device based on data points that may be available.

While this invention has been described in terms of several preferred embodiments, there are alterations, permutations, and equivalents, which fall within the scope of this invention. Although various examples are provided herein, it is intended that these examples be illustrative and not limiting with respect to the invention.

Also, the title and summary are provided herein for convenience and should not be used to construe the scope of the claims herein. Further, the abstract is written in a highly abbreviated form and is provided herein for convenience and thus should not be employed to construe or limit the overall invention, which is expressed in the claims. If the term “set” is employed herein, such term is intended to have its commonly understood mathematical meaning to cover zero, one, or more than one member. It should also be noted that there are many alternative ways of implementing the methods and apparatuses of the present invention. It is therefore intended that the following appended claims be interpreted as including all such alterations, permutations, and equivalents as fall within the the spirit and scope of the present invention.

What is claimed is:

1. An arrangement for managing a telecommunication session for a plurality of mobile communication devices that includes at least a first mobile communication device and a second mobile communication device, said first mobile communication device having implemented therein a mobility client software, comprising:
a mobility gateway, said mobility gateway configured to communicate with said mobility client software of said first mobile communication device, when said first mobile communication device is a subscriber of said mobility gateway, said mobility gateway including
computer readable code implementing a model configured for collecting and storing environmental data about a set of access points, wherein said environmental data includes
data collected during said telecommunication session between said first mobile communication device and said second mobile communication device, and
data collected during previous telecommunication sessions supported by said mobility gateway,
wherein said environmental data is employed by said mobility gateway to manage said telecommunication session for said first mobile communication device.

2. The arrangement of claim 1 wherein said environmental data about said set of access points includes at least one of
identification number for a wireless access point of said set of access points,
a set of coordinates for said wireless access point,
signal quality for said wireless access point at a specific time, and
traffic pattern for said wireless access point at said specific time.

3. The arrangement of claim 1 wherein said environmental data about said set of access points includes at least one of
identification number for a cellular access point of said set of access points,
a set of coordinates for said cellular access point,
signal quality for said cellular access point at a specific time, and
traffic pattern for said cellular access point at said specific time.

4. The arrangement of claim 1 wherein said environmental data about said set of access points is collected from a plurality of telecommunication sessions.

5. The arrangement of claim 1 wherein said environmental data about said set of access points is manually provided by an administrator, wherein said environmental data includes at least one of locations of said set of access points, policy rules defining conditions for said set of access points availability, policy rules defining hierarchy for establishing telecommunication sessions, and cost guidelines for establishing said telecommunication sessions.

6. The arrangement of claim 1 wherein said environmental data collected by said model is applied toward establishing future telecommunication sessions.

7. The arrangement of claim 1 wherein said environmental data collected by said model is applied toward maintaining said telecommunication session between said first mobile communication device and said second mobile communication device when one of said first mobile communication device and said second mobile communication device is roaming.

8. The arrangement of claim 1 wherein said model is configured to collect said environmental data from said first mobile communication device even if said first mobile communication device is not actively participating in a telecommunication session.

9. The arrangement of claim 1 wherein said mobile communication device is a mobile telephone.

10. A method for managing a telecommunication session with a mobile communication device, comprising:
updating a model with environment data collected about a set of access points;
performing a quality of service evaluation for said mobile communication device by analyzing said environmental data; and
managing said telecommunication session based on said quality of service evaluation, wherein said quality of service evaluation is configured for determining an access point of said set of access points to facilitate said telecommunication session.

11. The method of claim 10 wherein said quality of service evaluation is performed before a destination number is inputted into said mobile communication device.

12. The method of claim 10 wherein said quality of service evaluation is performed when at least a first digit of a destination number is inputted into said mobile communication device.

13. The method of claim 10 wherein said quality of service evaluation is performed during said telecommunication session between a first mobile communication device and a second mobile communication device when at least one of said first mobile communication device and said second mobile communication device is roaming.

14. The method of claim 10 wherein said model is updated with said environment data collected from a plurality of mobile communication devices, wherein each mobile communication device of said plurality of mobile communication devices includes a mobility client software that is configured for interacting with a mobility gateway, wherein said mobility gateway is configured for applying said environmental data toward establishing telecommunication sessions.

15. The method of claim 10 wherein said environmental data about said set of access points includes at least one of
identification number for an access point of said set of access points,
a set of coordinates for said access point,
signal quality for said access point at a specific time, and
traffic pattern for said access point at said specific time.

16. The method of claim 10 wherein said environmental data about said set of access point is manually provided by an administrator, wherein said environmental data includes at least one of locations of said set of access points, policy rules defining conditions for said set of access points availability, policy rules defining hierarchy for establishing telecommunication sessions, and cost guidelines for establishing said telecommunication sessions.

17. An article of manufacture comprising a program storage medium having computer readable code embodied therein, said computer readable code being configured for managing a telecommunication session with a mobile communication device, comprising:
code for updating a model with environment data collected about a set of access points;
code for performing a quality of service evaluation for said mobile communication device by analyzing said environmental data; and
code for managing said telecommunication session based on said quality of service evaluation, wherein said quality of service evaluation is configured for determining an access point of said set of access points to facilitate said telecommunication session.

18. The article of manufacturing of claim 17 wherein said quality of service evaluation is performed either before a destination number is entered into said mobile communication device or when at least a first digit of said destination number is entered into said mobile communication device.

19. The article of manufacturing of claim 17 wherein said code for performing said quality of service evaluation occurs during said telecommunication session between a first mobile communication device and a second mobile communication device while at least one of said first mobile communication device and said second mobile communication device is roaming.

20. The article of manufacturing of claim 17 wherein said code for updating said model is occurring when said environment data is collected from a plurality of mobile communication devices, wherein each mobile communication device of said plurality of mobile communication devices includes a mobility client software that is configured for interacting with a mobility gateway, wherein said mobility gateway is configured for applying said environmental data toward establishing telecommunication sessions.
